(19) United States
(12) Patent Application Publication
(10) Pub. No.: US 2025/0160414 A1
(43) Pub. Date: May 22, 2025

(54) AEROSOL PROVISION DEVICE COMPRISING A MAGNETIC FLUX CONCENTRATOR

(71) Applicant: NICOVENTURES TRADING LIMITED, London (GB)

(72) Inventors: Mark POTTER, London (GB); David NELSON, London (GB); Ross CABOT, London (GB); Andrew SUTTON, London (GB)

(21) Appl. No.: 18/841,049

(22) PCT Filed: Feb. 24, 2023
(86) PCT No.: PCT/EP2023/054709

§ 371 Date: Aug. 23, 2024

(30) Foreign Application Priority Data
Feb. 25, 2022 (GB) 2202619.9

(51) Int. Cl. A24F 40/465; A24F 7/02; A24F 40/20; H05B 6/10; H05B 6/36

(52) U.S. Cl. CPC A24F 40/465; A24F 7/02; A24F 40/20; H05B 6/105; H05B 6/365

(57) ABSTRACT

An aerosol provision device includes an aerosol generator having one or more magnetic field generators and one or more magnetic field shaping elements arranged to shape, focus, concentrate or collimate a varying magnetic field generated by the one or more magnetic field generators.

### RELATED APPLICATIONS

The present application is a National Phase entry of PCT Application No. PCT/EP2023/054709 filed Feb. 24, 2023, which claims priority to GB Application No. 2202619.9 filed Feb. 25, 2022, each of which is hereby incorporated by reference in their entirety.

### TECHNICAL FIELD

The present invention relates to an aerosol provision device, an aerosol generating system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Conventional aerosol provision devices comprise a cylindrical heating chamber into which a rod shaped consumable is inserted.

Next generation devices are contemplated wherein a consumable having a shape other than cylindrical is used, such as a consumable comprising a planar substrate. The planar substrate may comprise a susceptor to be heated by penetration with a varying magnetic field. For example, the planar substrate may comprise a card base layer having an aluminum foil layer adhered thereto. The aluminum foil layer may act as a susceptor. An aerosol generating material (i.e. gel) may be provided upon the aluminum foil layer (susceptor). The planar substrate may be inserted into an aerosol provision device and may be translated or rotated relative to a heating element.

It will be understood that in order to provide an on-demand experience that the time to first puff short be as short as possible.

It is therefore desired to provide an improved aerosol provision device.

### SUMMARY

According to an aspect there is provided an aerosol provision device comprising:
an aerosol generator comprising one or more magnetic field generators; and
one or more magnetic field shaping elements arranged to shape, focus, concentrate or collimate a varying magnetic field generated by the one or more magnetic field generators.

It has been found that the provision of one or more magnetic field shaping elements is beneficial in that the magnetic field shaping element(s) can focus, concentrate or collimate a varying magnetic field generated by the one or more magnetic field generators (which may comprise e.g. an induction or inductor heating element). As a result, the magnetic flux in a region of an aerosol generating article which is inserted, in use, into the aerosol provision device can be substantially increased. As a consequence, the time to first puff can be substantially reduced and a puff on-demand aerosol provision device can be provided. Furthermore, the area of the aerosol generating article which is heated and consumed may be reduced thereby enabling either: (i) a greater density of aerosol generating regions to be provided per aerosol generating article; and/or (ii) a smaller aerosol generating article to be provided which can still provide the same number of puffs.

Optionally, the aerosol generator may comprise one or more inductors, inductor elements or inductor coils.

Optionally, the one or more inductors, inductor elements or inductor coils may be substantially planar.

Optionally, the one or more magnetic field shaping elements may comprise one or more permanent magnets, ferromagnets or ferrimagnets.

Optionally, the aerosol provision device may further comprise a body portion and a removable mouthpiece, wherein the one or more permanent magnets, ferromagnets or ferrimagnets are arranged to releasably secure the mouthpiece to the body portion.

Alternatively, the one or more magnetic field shaping elements may comprise one or more inductors, inductor elements, inductor coils or electromagnets.

Optionally, the aerosol provision device may further comprise a reception region for receiving an aerosol generating article.

Optionally, the one or more magnetic field shaping elements may be arranged to shape, focus, concentrate or collimate a varying magnetic field generated by the one or more magnetic field generators on to a target region of the aerosol generating article.

Optionally, the aerosol generator may be arranged on a first side of the reception region and the one or more magnetic field shaping elements may be arranged on a second different side of the reception region.

Optionally, the aerosol provision device further comprises one or more ferritic elements.

The one or more ferritic elements may be arranged adjacent the magnetic field generator and helps to improve the frequency response of the magnetic field generator.

Optionally, the one or more ferritic elements comprise a ceramic compound composed of iron oxide (Fe₂O₃) combined chemically with one or more additional metallic elements.

Optionally, the one or more ferritic elements are arranged on the first side of the reception region.

Optionally, the one or more magnetic field generators have a first side and a second side, wherein the first side of the one or more magnetic field generators is arranged adjacent the one or more ferritic elements and wherein the second side of the one or more magnetic field generators is arranged adjacent the first side of the reception region.

According to various embodiments an aerosol provision device is provided comprising:
a reception region for receiving an aerosol generating article;
one or more aerosol generators comprising one or more magnetic field generators, wherein the one or more aerosol generators are arranged adjacent the reception region;
one or more ferritic elements arranged adjacent the one or more aerosol generators; and
one or more magnetic field shaping elements arranged to shape, focus, concentrate or collimate a varying magnetic field generated by the one or more magnetic field generators;
wherein the one or more aerosol generators are arranged on a first side of the reception region and wherein the one or more magnetic field shaping elements are arranged on a second different side of the reception region.

Optionally, the aerosol provision device may further comprise an aerosol chamber arranged to receive aerosol generated from the aerosol generating article.

Optionally, the aerosol provision device may further comprise a first device arranged to move, translate or rotate an aerosol generating article relative to the aerosol generator during a session of use.

Optionally, the aerosol provision device may comprise a plurality of magnetic field generators arranged to cause aerosol to be generated from different portions of an aerosol generating article during a session of use.

Optionally, the aerosol provision device may comprise a plurality of aerosol chambers, wherein at least some or each aerosol chamber is arranged to receive aerosol generated from different portions of an aerosol generating article during a session of use.

According to another aspect there is provided an aerosol provision device comprising:
an aerosol generator comprising one or more magnetic field generators; and
one or more magnetic flux concentrating elements arranged to concentrate magnetic flux generated by the one or more magnetic field generators.

It has been found that the provision of one or more magnetic flux concentrating elements acts to concentrate a magnetic flux generated by the one or more magnetic field generators (which may comprise e.g. an induction or inductor heating element). As a result, the magnetic flux in a region of an aerosol generating article which is inserted, in use, into the aerosol provision device can be substantially increased. As a consequence, the time to first puff can be substantially reduced and a puff on-demand aerosol provision device can be provided. Furthermore, the area of the aerosol generating article which is heated and consumed may be reduced thereby enabling either: (i) a greater density of aerosol generating regions to be provided per aerosol generating article; and/or (ii) a smaller aerosol generating article to be provided which can still provide the same number of puffs.

Optionally, the aerosol generator may comprise one or more inductors, inductor elements or inductor coils.

Optionally, the one or more inductors, inductor elements or inductors coils may be substantially planar.

Optionally, the one or more magnetic flux concentrating elements may comprise one or more permanent magnets, ferromagnets or ferrimagnets.

Optionally, the aerosol provision device may further comprise a body portion and a removable mouthpiece, wherein the one or more permanent magnets, ferromagnets or ferrimagnets are arranged to releasably secure the mouthpiece to the body portion.

Optionally, the one or more magnetic flux concentrating elements may comprise one or more inductors, inductor elements, inductor coils or electromagnets.

Optionally, the aerosol provision device may further comprise a reception region for receiving an aerosol generating article.

Optionally, the one or more magnetic flux concentrating elements may be arranged to concentrate a varying magnetic field generated by the one or more magnetic field generators on to a target region of the aerosol generating article.

Optionally, the aerosol generator may be arranged on a first side of the reception region and wherein the one or more magnetic flux concentrating elements may be arranged on a second different side of the reception region.

Optionally, the aerosol provision device further comprises one or more ferritic elements.

The one or more ferritic elements may be arranged adjacent the magnetic field generator and helps to improve the frequency response of the magnetic field generator.

Optionally, the one or more ferritic elements comprise a ceramic compound composed of iron oxide (Fe₂O₃) combined chemically with one or more additional metallic elements.

Optionally, the one or more ferritic elements are arranged on the first side of the reception region.

Optionally, the one or more magnetic field generators have a first side and a second side, wherein the first side of the one or more magnetic field generators is arranged adjacent the one or more ferritic elements and wherein the second side of the one or more magnetic field generators is arranged adjacent the first side of the reception region.

Optionally, the aerosol provision device may further comprise an aerosol chamber arranged to receive aerosol generated from the aerosol generating article.

Optionally, the aerosol provision device may further comprise a first device arranged to move, translate or rotate an aerosol generating article relative to the aerosol generator during a session of use.

Optionally, the aerosol provision device may comprise a plurality of magnetic field generators arranged to cause aerosol to be generated from different portions of an aerosol generating article during a session of use.

Optionally, the aerosol provision device may comprise a plurality of aerosol chambers, wherein at least some or each aerosol chamber is arranged to receive aerosol generated from different portions of an aerosol generating article during a session of use.

According to another aspect there is provided an aerosol generating system comprising:
an aerosol provision device as described above; and
an aerosol generating article comprising aerosol generating material and one or more susceptors.

Optionally, the aerosol generating article may comprise a planar aerosol generating article.

Optionally, the susceptor may comprise a metallic foil.

Optionally, the metallic foil may comprise aluminum foil.

According to another aspect there is provided a method of generating aerosol comprising:
providing an aerosol provision device as described above; and
introducing an aerosol generating article comprising aerosol generating material and one or more susceptors into the aerosol provision device.

Optionally, the method further comprises activating the aerosol provision device.

According to another aspect there is provided an aerosol provision device comprising:
a reception region for receiving an aerosol generating article;
one or more aerosol generators comprising one or more magnetic field generators, wherein the one or more aerosol generators are arranged on a first side of the reception region; and
one or more magnetic field shaping elements arranged to shape, focus, concentrate or collimate a varying magnetic field generated by the one or more magnetic field generators, wherein the one or more magnetic field shaping elements are arranged on a second different side of the reception region.

Optionally, the one or more magnetic field shaping elements comprise one or more inductors, inductor elements, inductor coils, electromagnets or ferritic material.

Optionally, the aerosol provision device further comprises one or more ferritic elements.

Optionally, the one or more ferritic elements comprise a ceramic compound composed of iron oxide (Fe₂O₃) combined chemically with one or more additional metallic elements.

Optionally, the one or more ferritic elements are arranged on the first side of the reception region.

Optionally, the one or more magnetic field generators have a first side and a second side, wherein the first side of the one or more magnetic field generators is arranged adjacent the one or more ferritic elements and wherein the second side of the one or more magnetic field generators is arranged adjacent the first side of the reception region.

### BRIEF DESCRIPTION OF THE DRAWINGS

Various embodiments will now be described, by way of example only, and with reference to the accompanying drawings, in which:

FIG. 1 shows a cross-section of a schematic representation of an aerosol provision device and an aerosol generating article, the aerosol provision device comprising a plurality of induction coils and the aerosol generating article comprising a plurality of portions of aerosol generating material and corresponding susceptor portions;

FIG. 2 shows an aerosol provision device in combination with an aerosol generating article, wherein the aerosol generating article comprises a plurality of portions of aerosol generating material and wherein the aerosol provision device comprises a single inductive heating element and a movement mechanism for rotating the aerosol generating article relative to the single inductive heating element;

FIG. 3A shows a plan view of an aerosol generating article, FIG. 3B shows an end-on view of the aerosol generating article and shows a plurality of susceptors embedded into the aerosol generating article and FIG. 3C shows a side view of the aerosol generating article and shows a plurality of susceptors embedded into the aerosol generating article;

FIG. 4A shows a perspective view of an aerosol provision device wherein a slidable clasp is used to secure an upper lid portion of the aerosol provision device having a mouthpiece to a lower base portion, FIG. 4B shows a perspective view with the slidable clasp removed and FIG. 4C shows a perspective view showing the lid of the aerosol provision device open and an aerosol generating article inserted into the aerosol provision device;

FIG. 5 shows a portion of an aerosol provision device according to various embodiments wherein an aerosol chamber and mouthpiece have been removed and wherein one or more magnets are located in the upper lid portion of the aerosol provision device, wherein the one or more magnets act as one or more magnetic field shaping element or magnetic flux concentrating elements to concentrate the magnetic flux emitted by one or more inductor coils located in the base portion of the aerosol provision device;

FIG. 6 shows an aerosol provision device wherein an aerosol generating article comprising a card substrate, aluminum foil susceptor layer and an aerosol generating material layer is located within a reception region of the aerosol provision device such that the aerosol generating article is located above an inductor coil and below one or more permanent magnets located in a lid portion of the aerosol provision device, wherein the one or more permanent magnets are arranged to shape the magnetic field generated by the one or more inductor coils;

FIG. 7 shows how the temperature of the aluminum foil susceptor layer was determined to vary during an initial 4 s calibration period wherein the temperature (TC) was directly measured by a thermocouple and wherein a calculated temperature (TCalc) as determined by a control system monitoring the resonance frequency of the inductive heating element is shown for comparison purposes, wherein the results shown were obtained without a magnet being located in the vicinity of the aluminum foil susceptor to shape the magnetic field;

FIG. 8 shows how the temperature of the aluminum foil susceptor layer was determined to vary during an initial 4 s calibration period wherein the temperature (TC) was directly measured by a thermocouple and wherein a calculated temperature (TCalc) as determined by a control system monitoring the resonance frequency of the inductive heating element is shown for comparison purposes, wherein the results shown were obtained with a permanent magnet being located above the aluminum foil susceptor layer and wherein the magnet acted as a magnetic field shaping element or magnetic flux concentrating element;

FIG. 9 shows a table summarising the test data obtained both with and without a permanent magnet being located above an aluminum foil susceptor layer and shows how the time to reach the maximum directly measured temperature (TC_{Max}) was reduced from 1.8 s (when no magnet is present) to 1.2 s when a magnet is present which shapes the magnetic field according to various embodiments;

FIG. 10 shows how the determined resonance of a resonance circuit (and hence the calculated temperature of an aluminum foil susceptor layer) was determined to decrease as a function of time both when no magnet was located above the aluminum foil susceptor layer and also when a permanent magnet was located above the aluminum foil susceptor layer in order to shape the magnetic field according to various embodiments; and

FIG. 11 shows a test aerosol generating article comprising an aluminum foil susceptor layer which was used in an aerosol provision device and shows how different size blisters were formed in the aluminum foil susceptor layer, wherein the size of the blisters was dependent upon whether or not a magnet was located above the aluminum foil susceptor layer and the associated inductor heating element.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with aerosol provision devices. These consumables are sometimes referred to as articles throughout the disclosure.

In some embodiments, the aerosol provision system, such as an aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the aerosol provision system may comprise an area for receiving the consumable, an aerosol generator, an aerosol generation area, a housing, a mouthpiece, a filter and/or an aerosol-modifying agent.

In some embodiments, the consumable for use with the aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be an aerosol-generating film. The aerosol-generating film may be formed by combining a binder, such as a gelling agent, with a solvent, such as water, an aerosol-former and one or more other components, such as active substances, to form a slurry and then heating the slurry to volatilize at least some of the solvent to form the aerosol-generating film. The slurry may be heated to remove at least about 60 wt %, 70 wt %, 80 wt %, 85 wt % or 90 wt % of the solvent. The aerosol-generating film may be a continuous film or a discontinuous film, such an arrangement of discrete portions of film on a support. The aerosol-generating film may be substantially tobacco free.

The aerosol-generating film may comprise or be a sheet, which may optionally be shredded to form a shredded sheet.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Aerosol provision systems may comprise a modular assembly including both a reusable aerosol provision device and a replaceable aerosol generating article. In some implementations, the aerosol provision device may comprise a power source and a controller (or control circuitry). The power source may, for example, comprise an electric power source, such as a battery or rechargeable battery. In some implementations, the aerosol provision device may also comprise an aerosol generating component. However, in other implementations the aerosol generating article may comprise partially, or entirely, the aerosol generating component.

Induction heating is a process in which an electrically-conductive object, referred to as a susceptor, is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents and when such eddy currents are generated in the object, their flow against the electrical resistance of the object causes the object to be heated. This process is called Joule, ohmic or resistive heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

Various embodiments will now be described in more detail.

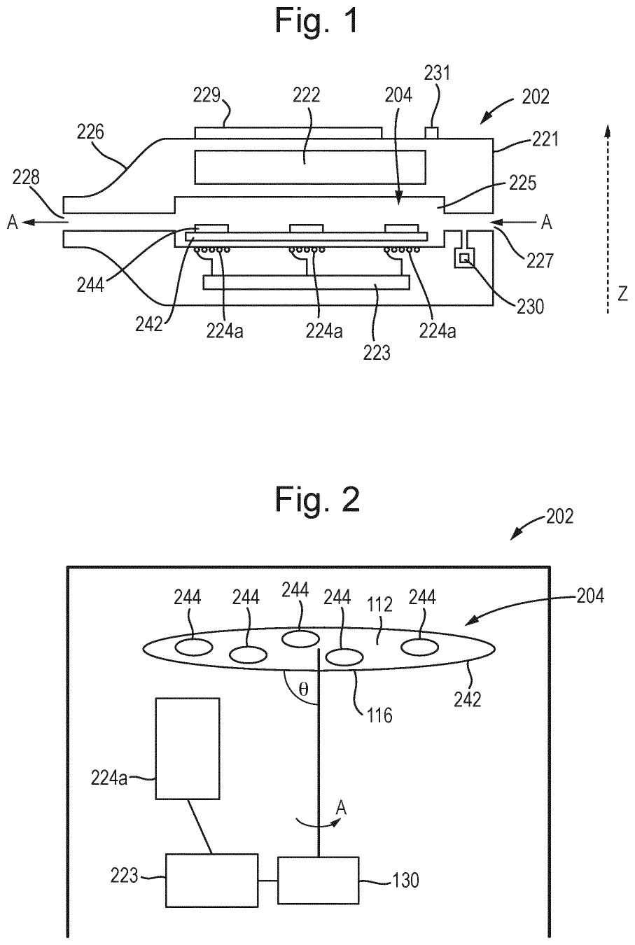

FIG. 1 shows a cross-sectional view through a schematic representation of an aerosol provision system in accordance with an arrangement. An aerosol provision device 202 is shown comprising an outer housing 221, a power source 222, control circuitry 223, induction heating elements such as one or more induction coils 224a, a reception region or aerosol forming chamber 225, a mouthpiece end 226, an air inlet 227, an air outlet 228, a touch-sensitive panel 229, an inhalation sensor 230 and an end of use indicator 231.

The one or more induction heating elements 224a may comprise one or more of: (i) a flat spiral coil, wherein the spiral coil comprises a circular or ovular spiral, a square or rectangular spiral, a trapezoidal spiral or a triangular spiral; (ii) a multi-layered induction arrangement wherein subsequent full or partial turns of the coil are provided on adjacent layers, optionally wherein a first layer is spaced from a second layer in a first direction and a third layer is spaced from the second layer in the opposite direction to reside in or close to the first layer such that the multi-layered induction arrangement forms a staggered structure; or (iii) a three-dimensional inductor coil, such as a regular helix or a conically shaped inductor coil, optionally with a varying helical pitch.

The aerosol provision device 202 may comprise a lid portion, a base portion, and a securing portion.

The outer housing 221 may be formed from any suitable material, for example a plastics material. The outer housing 221 may be arranged such that the power source 222, control circuitry 223, one or more induction coils 224a, reception region 225 and inhalation sensor 230 are located within the outer housing 221. The outer housing 221 also defines the air inlet 227 and air outlet 228. The touch sensitive panel 229 and end of use indicator 231 may be located on the exterior of the outer housing 221.

The outer housing 221 further includes a mouthpiece end 226. The outer housing 221 and mouthpiece end 226 may be formed as a single component (that is, the mouthpiece end 226 may form a part of the outer housing 221).

Other arrangements are contemplated wherein the mouthpiece 226 may be detachable from the outer housing 221. The mouthpiece end 226 may comprise a removable component that is separate from but able to be coupled to the outer housing 221, and may be removed for cleaning and/or replacement with another mouthpiece end 226. The mouthpiece end 226 may be retained in the housing 21 by one or more magnets.

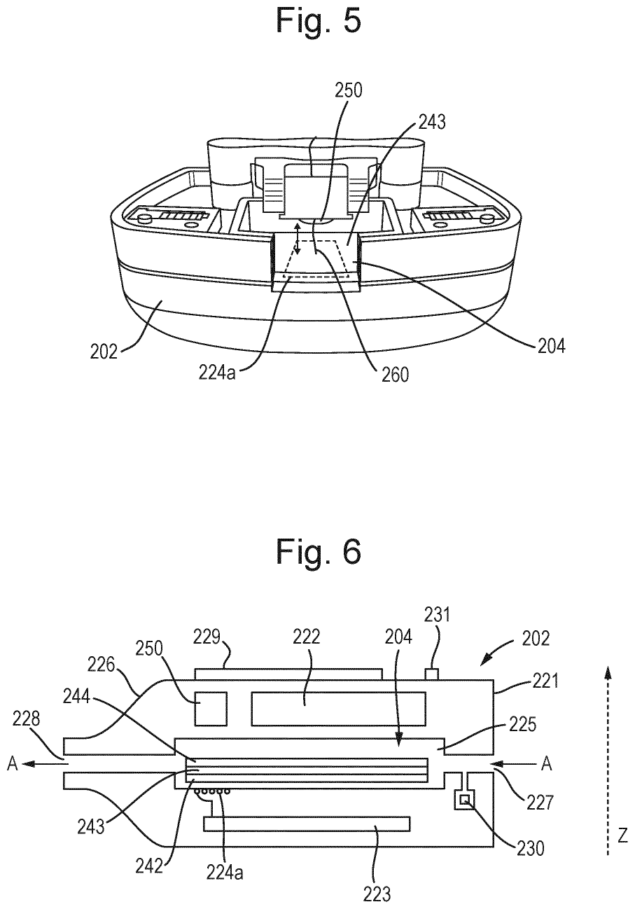

According to various embodiments one or more magnetic field shaping elements may be provided which are arranged to shape, focus, concentrate or collimate a varying magnetic field generated by one or more magnetic field generators which may comprise one or more induction coils 224a. The one or more magnetic field shaping elements are not shown in FIGS. 1-4 for clarity purposes but will be described in more detail below with reference to FIGS. 5 and 6.

In addition, one or more ferritic elements (not shown) may be provided below the one or more induction coils 224a. The one or more ferritic elements have been found to improve the frequency response of the one or more induction coils 224a. In particular, the one or more ferritic elements help to reduce any variation in the resonance frequency of the one or more induction coils 224a. The one or more ferritic elements help to improve the performance of the aerosol provision device 202 and help to ensure that a susceptor provided e.g. as part of an aerosol generating article 204 is heated more quickly and become hotter than would otherwise be the case if the one or more ferritic elements were not provided.

The power source 222 may be configured to provide operating power to the aerosol provision device 202. The power source 222 may comprise any suitable power source, such as a battery. For example, the power source 222 may comprise a rechargeable battery, such as a Lithium Ion battery (“LIB”). The power source 222 may be removable or form an integrated part of the aerosol provision device 202. The power source 222 may be recharged through connection of the aerosol provision device 202 to an external power supply (such as mains power) through an associated connection port, such as a USB port (not shown) or via a suitable wireless receiver (not shown).

The control circuitry 223 may be suitably configured or programmed to control the operation of the aerosol provision device 202 to provide certain operating functions of the aerosol provision device 202. The control circuitry 223 may be considered to logically comprise various sub-units or circuitry elements associated with different aspects of the operation of the aerosol provision devices 202. For example, the control circuitry 223 may comprise a logical sub-unit for controlling the recharging of the power source 222. Additionally, the control circuitry 223 may comprise a logical sub-unit for communication e.g. to facilitate data transfer from or to the aerosol provision device 202. However, a primary function of the control circuitry 223 is to control the aerosolization of aerosol generating material, as described in more detail below.

It will be appreciated the functionality of the control circuitry 223 can be provided in various different ways, for example using one or more suitably programmed programmable computer(s) and/or one or more suitably configured application-specific integrated circuit(s), circuitry, chip(s) or chipset(s) configured to provide the desired functionality. The control circuitry 223 may be connected to the power supply 222 and may receive power from the power source 222 and may be configured to distribute or control the power supply to other components of the aerosol provision device 202.

The aerosol provision device 202 may further comprises a reception region 225 which is arranged to receive an aerosol generating article 204. The reception region 225 may be suitable sized to removably receive the aerosol generating article 204 therein. The aerosol generating article 204 may comprise a carrier component or substrate (e.g. card) 242, one or more susceptors or a susceptor layer and aerosol generating material 244 provided on the one or more susceptors or the susceptor layer. According to an arrangement a single susceptor layer may be provided wherein the single susceptor layer comprises an aluminum foil layer or a metallic foil layer. The aerosol provision device 202 may comprise a lid portion and a base portion which are configured to engage with each other. A securing mechanism may be provided in order to secure the lid portion to the base portion. Various configurations for the lid and base portions are contemplated. The aerosol provision device 202 may comprise a hinged door or removable part of the outer housing 221 to permit access to the reception region 225 such that a user may insert and/or remove an aerosol generating article 204 into/from the reception region 225. The hinged door or removable part of the outer housing 221 may also act to retain the aerosol generating article 204 within the reception region 225 when closed.

According to embodiments, one or more ferritic elements (not shown) may be provided below the one or more induction coils 224a. Accordingly, the one or more ferritic elements and the one or more induction coils 224a are provided on one side of the reception region 225. On the other side of the reception region 225 e.g. above the reception region 225, one or more magnetic field shaping elements may be provided.

When an aerosol generating article 204 is exhausted or the user simply wishes to switch to a different aerosol generating article 204, the aerosol generating article 204 may be removed from the aerosol provision device 202 and a replacement aerosol generating article 204 may be positioned in the reception region 225 in its place.

The aerosol provision device 202 may include a permanent opening that communicates with the reception region 225 through which the aerosol generating article 204 can be inserted into the reception region 225. In such implementations, a retaining mechanism for retaining the aerosol generating article 204 within the reception region 225 of the aerosol provision device 202 may be provided.

The retaining mechanism may comprise a securing mechanism configured to engage the lid portion with the base portion so as to hold in position, in use, an aerosol generating article 204 so as to prevent relative movement of the aerosol generating article 204. For example, the lid portion and the base portion may be configured so as to hold the aerosol generating article 204 in position in between the lid portion and the base portion.

FIG. 2 illustrates a schematic view of a portion of an aerosol provision device 202 according to an arrangement. The aerosol provision device 202 is shown with an aerosol generating article 204 which comprises aerosol generating material located within the aerosol provision device 202. The combination of the aerosol provision device 202 and the aerosol generating article 204 together form an aerosol provision system.

The aerosol generating article 204 has a first upper surface 112 upon which aerosol generating material 244 may be arranged. The aerosol generating article 204 may include a carrier layer 242 (which may be referred to herein as a carrier or a substrate supporting layer) and a susceptor layer on which the aerosol generating material 244 may be disposed. The aerosol generating material 244 may be arranged as a plurality of doses of the aerosol generating material. The aerosol generating article 204 has a second lower surface 116 on the opposite side to the first surface 112. The first surface 112 and/or the second surface 116 may be smooth or rough. The aerosol provision device 202 may comprise one or more induction heating elements 224a arranged to face the second surface 116 of the aerosol generating article 204. The one or more induction heating elements 224a may be arranged to transfer energy from a power source, such as a battery (not shown), to the aerosol generating material 244 in order to generate aerosol from the aerosol generating material 244.

The aerosol provision device 202 may have a movement mechanism 130 arranged to move the aerosol generating article 204, and in particular portions (or, in some cases, doses) of aerosol generating material 244. The portions of aerosol generating material 244 may be rotated relative to one or more inductive heating element(s) or induction coil(s) 224a such that portions of the aerosol generating material 244 are presented, in this case individually, to the inductive heating element(s) or induction coil(s) 224a. In the arrangement shown in FIG. 2 the inductive heating element 224a may comprise an induction coil and the aerosol generating article 204 includes a layer that acts as a susceptor.

The aerosol provision device 202 may be arranged such that at least one dose of the aerosol generating material 244 is rotated around an axis A at an angle θ to the second surface 116. Control circuitry 223 may be configured to actuate both the inductive heating element(s) or induction coil(s) 224a and the movement mechanism 130 such that the aerosol generating article 204 rotates so as to align a discrete portion of aerosol generating material 244 in close proximity to the inductive heating element(s) or induction coil(s) 224a. The aerosol generating article 204 may be substantially flat or planar. The carrier layer 242 of the aerosol generating article 204 may be formed of partially or entirely of paper or card.

The aerosol generating article 204 shown in FIG. 2 comprises five doses (or portions) of aerosol generating material 244. In other examples, the aerosol generating article 204 may have more or fewer doses of aerosol generating material 244. In some examples, the aerosol generating article 204 may have the doses of aerosol generating material 244 arranged in discrete doses as shown in FIG. 2.

In other examples, the doses may be in the form of a disc, which may be continuous or discontinuous in the circumferential direction of the aerosol generating article 204. In still other examples, the doses may be in the form of an annulus, a ring or any other shape. The aerosol generating article 204 may or may not have a rotationally symmetrical distribution of doses on the first surface 112 about the axis A. A symmetrical distribution of doses would enable equivalently positioned doses (within the rotationally symmetrical distribution) to receive an equivalent heating profile from the inductive heating element(s) or induction coil(s) 224a upon rotation about the axis A, if desired.

The aerosol generating article 204 of the present example includes aerosol generating material 244 disposed on a susceptor layer of the aerosol generating article 204. However, in other implementations, the aerosol generating article 204 may be formed exclusively of aerosol generating material 244; that is, in some implementations, the aerosol generating article 204 may consist entirely of aerosol generating material 244. In this example, one or more susceptor elements may be provided as part of the aerosol provision device 202.

The aerosol generating article 204 may have a layered structure and may be formed from a plurality of materials. In one example, the aerosol generating article 204 may have a layer formed from at least one of a thermally conductive material, an inductive material, a permeable material or an impermeable material.

In some implementations, the carrier layer 242 or the substrate may be, or may include, a metallic element that is arranged to be heated by a varying magnetic field and hence may act as a susceptor layer. In such implementations, the inductive heating element 224a may include one or more induction coils 224a, which, when energised, cause heating within the metallic element of the aerosol generating article 204. The degree of heating may be affected by the distance between the metallic element or susceptor layer and the induction coil 224a.

The arrangement shown in FIG. 2 operates by indexing (or moving) the plurality of doses of aerosol generating material 242 relative to the inductive heating element(s) or induction coil(s) 224a. While this arrangement of FIG. 2 may have a slight increase in the complexity of the movement mechanism 130 to provide movement to the aerosol generating article 204, there are benefits to be had by virtue that the aerosol provision device 204 may comprise a single inductive heating element 224a which is used to heat a plurality of portions of aerosol generating material 244. It will be understood that a single heating element 224a requires a single control mechanism (such as control circuitry 223) whereas a plurality of heaters may each require separate control mechanisms. As such, this arrangement can reduce the cost and control complexity in relation to the operation and control of the inductive heating element 224a.

The shape of the aerosol provision device 202 may be cigarette-shape (longer in one dimension than the other two) or may be other shapes. In an example, the aerosol provision device 202 may have a shape that is longer in two dimensions than the other one, for example like a compact-disc player or the like. Alternatively, the shape may be any shape that can suitably house the aerosol generating article 204, one or more inductive heating element(s) or induction coil(s) 224a and the movement mechanism 130.

The aerosol generating article 204 may comprise a carrier component 242 which may be formed of card. The carrier component 242 may form the majority of the aerosol generating article 204 and may act as a base for one or more susceptors or a susceptor layer with aerosol generating material 244 provided or deposited thereupon. The carrier component 242 may be broadly cuboidal in form. The carrier component 242 may have a length of 30-80 mm, a width 7-25 mm and a thickness 0.2 mm. However, it should be appreciated that other arrangements are contemplated wherein the carrier component 242 may have different dimensions as appropriate.

The aerosol generating article 204 may comprise a plurality of discrete portions of aerosol generating material 244 disposed on a surface of the carrier component 242. The aerosol generating article 204 may comprise two, three, four, five, six, seven, eight, nine, ten, eleven, twelve, thirteen, fourteen, fifteen or more than fifteen discrete portions of aerosol generating material 244.

The discrete portions of aerosol generating material 244 may be disposed in a n×m array. However, it should be appreciated that in other implementations a greater or lesser number of discrete portions may be provided and/or the portions may be disposed in a different format array (e.g. a one by six array). Other arrangements are contemplated wherein the aerosol generating article 204 comprises a disc and separate portions of aerosol generating material 244 are provided in separate segments of the disc.

The aerosol generating material 244 may be disposed at discrete separate locations on a single surface of the component carrier 242. The discrete portions of aerosol generating material 244 are shown as having a circular footprint, although it should be appreciated that the discrete portions of aerosol generating material 244 may take any other footprint, such as square, trapezoidal or rectangular, as appropriate. The discrete portions of aerosol generating material 244 may be arranged separate from one another such that each of the discrete portions may be energised (e.g. heated) individually or selectively to produce an aerosol.

The aerosol generating article 204 may comprise a plurality of portions of aerosol generating material 244 all formed from the same aerosol generating material. Alternatively, the aerosol generating article 204 may comprise a plurality of portions of aerosol generating material 244 where at least two portions are formed from different aerosol generating materials.

The one or more inductive heating element(s) or induction coil(s) 224a may be positioned such that a surface of the one or more inductive heating element(s) or induction coil(s) 224a forms a part of the surface of the reception region 225. That is, an outer or upper surface of the one or more inductive heating element(s) or induction coil(s) 224a is flush with the inner surface of the reception region 225.

The one or more inductive heating element(s) or induction coil(s) 224a may be arranged such that, when the aerosol generating article 204 is received in the reception region 225, each inductive heating element or induction coil 224a aligns with a corresponding discrete portion of aerosol generating material 244. For example, if six inductive heating elements or induction coils 224a are arranged in a two by three array then the aerosol generating article 204 may comprise a two by three array of the six discrete portions of aerosol generating material 244. However, as discussed above, the number of inductive heating elements or induction coils 224a may be different in different implementations. For example, according to various arrangements 1, 2, 3, 4, 5, 6, 7, 8, 9, 10, 11, 12, 13, 14, 15, 16, 17, 18, 19 or 20 separate inductive heating elements or inductions coils 224a may be provided.

Each of the inductive heating element(s) or induction coil(s) 224a can be individually activated to heat a corresponding portion of aerosol generating material 244. While the inductive heating elements or induction coils 224a are shown flush with the inner surface of the reception region 225, in other implementations the inductive heating elements or induction coils 224a may protrude into the reception region 225.

In arrangements wherein the aerosol generating article 204 is configured to move in a specified or desired direction relative to the one or more inductive heater elements or induction coils 224a, the securing mechanism may be configured to engage the lid portion with the base portion so as to hold in position the aerosol generating article 204 to prevent relative movement of the aerosol generating article 204 thereby preventing relative movement in a direction other than in the specified or desired direction.

For example, in arrangements wherein the aerosol generating article 204 is configured to rotate about a rotation axis relative to the one or more inductive heater elements or induction coils 224a so as to present to the one or more inductive heater elements or induction coils 224a a fresh region of aerosol generating material on the aerosol generating article 204, the securing mechanism may be configured to engage the lid portion with the base portion so as to still enable the aerosol generating article 204 to be rotated relative to the one or more inductive heater elements or induction coils 224a whilst preventing relative movement of the aerosol generating article 204 in a direction other than rotation about the rotation axis.

The one or more induction coils 224a may be provided adjacent the reception region 225 and may comprise generally flat coils arranged such that the rotational axis about which a given coil is wound extends into the reception region 225 and is broadly perpendicular to the plane of the carrier component 242 of the aerosol generating article 204.

The control circuitry 223 may comprise a mechanism to generate an alternating current which is passed to any one or more of the induction coils 224a. The alternating current generates an alternating magnetic field which in turn causes the corresponding susceptor(s) or a portion of a susceptor layer to heat up. The heat generated by the susceptor(s) or a portion of a susceptor layer is transferred to the portions of aerosol generating material 244 accordingly.

The control circuitry 223 may be configured to supply current to the induction coils 224a in response to receiving signalling from the touch sensitive panel 229 and/or the inhalation sensor 230.

Various arrangements have been described wherein one or more susceptors are provided as part of aerosol generating article 204. However, other arrangements are contemplated wherein one or more susceptors are located within or as part of the aerosol provision device 202. For example, one or more susceptors may be provided above the one or more induction coils 224a and may be arranged such that the one or more susceptors contact the lower surface of the carrier component 242.

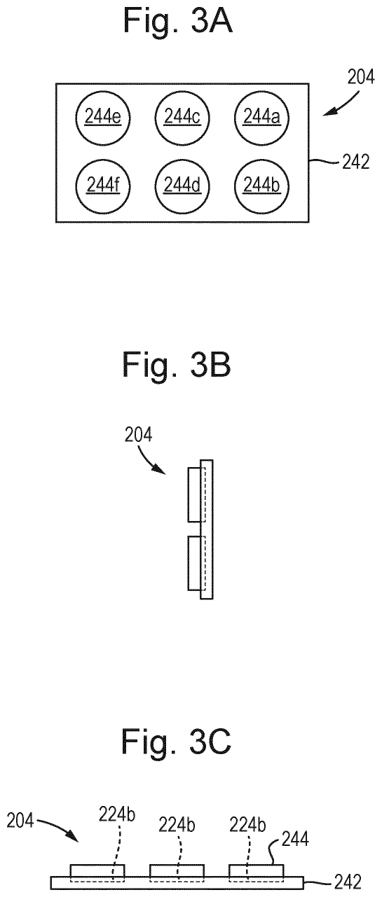

An aerosol generating article 204 for use with the aerosol provision device 202 may comprise a carrier component 242, one or more susceptor elements 224b and one or more portions of aerosol generating material 244a-f as shown and described in more detail with reference to FIGS. 3A-3C.

FIG. 3A shows a top-down view of an aerosol generating article 204 according to an arrangement, FIG. 3B shows an end-on view along the longitudinal (length) axis of the aerosol generating article 204 according to an arrangement and FIG. 3C shows a side-on view along the width axis of the aerosol generating article 204 according to an arrangement.

The one or more susceptor elements 224b may be formed from aluminum foil, although it should be appreciated that other metallic and/or electrically conductive materials may be used in other implementations. As seen in FIG. 3C, the carrier component 242 may comprise a number of susceptor elements 224b which correspond in size and location to the discrete portions of aerosol generating material 244a-f disposed on the surface of the carrier component 242. That is, the susceptor elements 224b may have a similar width and length to the discrete portions of aerosol generating material 244a-f.

The susceptor elements 224b are shown embedded in the carrier component 242. However, in other arrangements, the susceptor elements 224b may be placed or located on the surface of the carrier component 242. According to another arrangement a susceptor may be provided as a single layer substantially covering the carrier component 244. According to an arrangement the aerosol generating article 204 may comprise a substrate or support layer, a single layer of aluminum foil which acts as a susceptor and one or more regions of aerosol generating material 244 deposited upon the aluminum foil susceptor layer.

According to an arrangement an array of induction heating coils 224a may be provided to energise the discrete portions of aerosol generating material 244. However, according to other arrangements a single induction coil 224a may be provided and the aerosol generating article 204 may be configured to move relative to the single induction coil 224a. Accordingly, there may be fewer induction coils 224a than discrete portions of aerosol generating material 244 provided on the carrier component 242 of the aerosol generating article 204, such that relative movement of the aerosol generating article 204 and induction coil(s) 224a is required in order to be able to individually energise each of the discrete portions of aerosol generating material 244.

Alternatively, a single induction coil 224a may be provided and the aerosol generating article 204 may be rotated relative to the single induction coil 224a.

For example, a movable inductive heating element may be provided within the reception region 225 such that the inductive heating element may move relative to the reception region 225. In this way, the movable inductive heating element can be translated (e.g. in the width and length directions of the carrier component 242) such that the inductive heating element 224a can be aligned with respective ones of the discrete portions of aerosol generating material 244.

Although the above has described implementations where discrete, spatially distinct portions of aerosol generating material 244 are deposited on a carrier component 242, it should be appreciated that in other implementations the aerosol generating material 244 may not be provided in discrete, spatially distinct portions but instead be provided as a continuous sheet, film or layer of aerosol generating material 244. In these implementations, certain regions of the sheet of aerosol generating material 244 may be selectively heated to generate aerosol in broadly the same manner as described above.

Although it has been described above that the heating elements 224a are arranged to provide heat to aerosol generating material 244 (or portions thereof) at an operational temperature at which aerosol is generated from the portion of aerosol generating material 244, in some implementations, the one or more inductive heating elements or induction coils 224a and associated susceptor element(s) may be arranged to pre-heat portions of the aerosol generating material to a pre-heat temperature (which is lower than the operational temperature). At the pre-heat temperature, a lower amount or no aerosol is generated when the portion is heated at the pre-heat temperature.

It will be appreciated that, whilst each of the one or more inductive heating elements or induction coils 224a may provide the same heating profile to a respective aerosol generating region, one or more of the inductive heating elements or induction coils 224a may instead be configured to provide a different heating profile to different respective aerosol generating regions.

The aerosol provision device 202 may comprise a rotating device configured to rotate, about a rotation axis, the aerosol generating article 204. The rotation device may be configured to rotate the aerosol generating article 204 relative to one or more induction coil(s) 224a so that one or more fresh aerosol generating regions of the aerosol generating article 204 are moved into proximity to the one or more induction coil(s) 224a. A securing mechanism may be configured to enable the aerosol generating article 204 to be rotated relative to the one or more inductions coil(s) 224a whilst preventing relative movement of the aerosol generating article 204 in a direction other than rotation about the rotation axis, such as in the z-direction as indicated in FIG. 1.

The lid portion may comprise a plenum and a mouthpiece. In some arrangements, the mouthpiece and plenum may be integral with the lid portion. It will be understood that an integrated mouthpiece and lid portion ensures even compression on an aerosol generating article 204. That is, there is substantially no additional mechanical play or variance arising from a connection between the mouthpiece and the lid portion if they are a single integral piece. As a result, the force exerted by the lid portion onto the aerosol generating article 204 is substantially constant across the upper lid-facing surface of the aerosol generating material.

However, other arrangements are contemplated wherein the aerosol provision device 202 comprises a removable mouthpiece which may be retained within the housing of the aerosol provision device 202 by one or more magnets. The one or more magnets may also function as a magnetic field shaping element or magnetic flux concentrating element as will be described in more detail below. It is also contemplated that the plenum may also be removable.

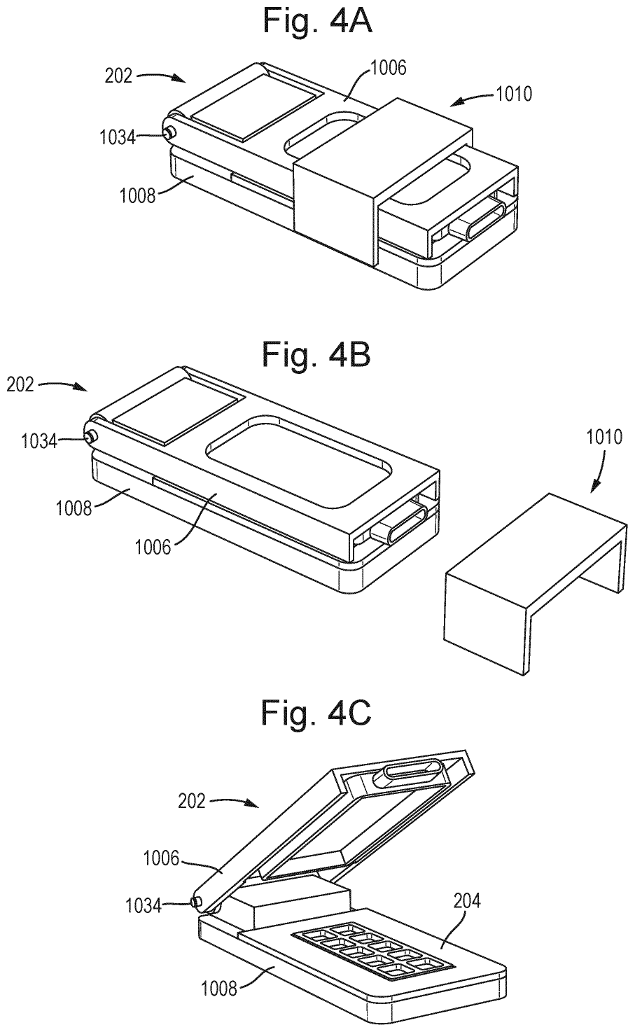

FIG. 4A shows an aerosol provision device according to an embodiment comprising a lid portion 1006 and a base portion 1008. A securing mechanism 1010 may be provided which comprises a clasp such as a slidable clasp configured to clamp the lid portion 1006 of the aerosol provision device 202 to the base portion 1008 so as to engage the lid portion 1006 with the base portion 1008. Alternatively or additionally, the securing mechanism may comprise a rotatable clasp. The lid portion 1006 may pivot about a hinge mechanism 1034.

The lid portion 1006 and/or the base portion 1008 may comprise one or more walls configured to form, when the lid portion 1006 is engaged with the base portion 1008, an aerosol chamber or an aerosol forming chamber. The lid portion 1006 and/or the base portion 1008 may uniformly apply a pressure through the one or more walls on to a substantially planar aerosol generating article so as to prevent relative movement of the aerosol generating article.

FIG. 4B shows the securing mechanism 1010 removed and FIG. 4C shows the lid portion 1006 in an open position with an aerosol generating article 204 inserted into or within the aerosol provision device 202.

The aerosol provision device 202 as shown in FIGS. 1-4 and described above further comprises one or more magnets 250 as shown in FIGS. 5 and 6. The one or more magnets 250 function to shape the magnetic field or concentrate the magnetic flux emitted from one or more inductor coils 224a located, for example, in a base portion of the aerosol provision device 202. It is also contemplated that the one or more magnets 250 may be arranged to secure a removable mouthpiece (not shown) to the housing of the aerosol provision device 202.

However, it is not essential that the one or more magnets 250 help to secure a removable mouthpiece to the housing and indeed it is contemplated that the mouthpiece 226 may be integral with the housing and may be non-removable.

FIG. 5 shows an aerosol provision device 202 according to an embodiment wherein the upper lid portion and associated removable mouthpiece have been removed. The aerosol provision device 202 comprises an aerosol generator. The aerosol generator may comprise one or more magnetic field generators such as one or more inductor coils 224a. A test aerosol generating article or consumable 204 is shown located within the aerosol provision device 202. The aerosol generating article or consumable 204 may be disc shaped and may comprise a substrate which may comprise, for example, a layer of card upon which a layer of aluminum foil 243 is adhered. The aluminum foil layer 243 may have a thickness of 25 μm and the aluminum foil layer 243 may function as a susceptor.

One or more ferritic elements (not shown) may be provided below the one or more inductor coils 224a. The one or more ferritic elements have been found to improve the frequency response of the one or more inductor coils 224a.

It will be understood that a commercially available aerosol generating article or consumable 204 would further comprise a layer of aerosol generating material (e.g. gel) provided upon the aluminum foil layer 243. However, in some instances for testing and device calibration purposes a test aerosol generating article 204 comprising just a card substrate with an aluminum foil layer 243 adhered thereto was tested. In other instances a test aerosol generating article 204 comprising a card substrate, an aluminum foil layer 243 which functioned as a susceptor and a layer of aerosol generating material was tested.

As discussed above, the aerosol provision device 202 according to various embodiments further comprises one or more magnets 250. The one or more magnets 250 function to shape the magnetic field or concentrate the magnetic flux emitted from one or more inductor coils 224a located, for example, in a base portion of the aerosol provision device 202. It is also contemplated that the one or more magnets 250 may be arranged to secure a removable mouthpiece (not shown) to the housing of the aerosol provision device 202.

However, it is not essential that the one or more magnets 250 help to secure a removable mouthpiece to the housing and indeed it is contemplated that the mouthpiece 226 may be integral with the housing and may be non-removable.

As shown in FIG. 5 one or more magnets 250 may be located vertically above one or more inductor coils 224a. The one or more inductor coils 224a are hidden from view and are located in a lower section or base portion of the aerosol provision device 202. The position of the one or more inductor coils 224a are indicated by dashed lines. The one or more magnets 250 function as one or more magnetic field shaping or magnetic flux concentrating elements. According to various embodiments one, two, three or more than three magnets 250 may be provided and function as magnetic field shaping or magnetic flux concentrating elements.

The inductor coil 224a may have a trapezoidal profile as indicated in FIG. 5 or alternatively the inductor coil 224a may have a circular profile. Other embodiments are contemplated wherein the inductor coil 224a may have a different profile.

For testing and calibration purposes a thermocouple 260 is shown attached to the upper surface of the test aerosol generating article 204 i.e. to the aluminum foil layer 243. It will be understood that the aluminum foil disc layer as a susceptor 243 and in use it will be heated by magnetic induction by the inductor coil 224a. If aerosol generating material were to be provided upon the upper surface of the aluminum foil susceptor layer 243 then the aerosol generating material will become heated and at a certain temperature will form an aerosol which may then be inhaled by a user.

The thermocouple 260 was provided for testing and calibration purposes. In particular, the thermocouple 260 was provided in order to measure the temperature of the susceptor 243 of the aerosol generating article 204 during testing and initial calibration of the aerosol provision device 202.

FIG. 6 shows an aerosol provision device 202 according to an embodiment wherein a magnet 250 is provided above an induction coil 224a in order to shape the magnetic field or concentrate the magnetic flux emitted by the induction coil 224a. An aerosol generating article 204 is shown received within a reception region 225 of the aerosol provision device 202 and comprises a support or substrate layer 242, a susceptor layer 243 and a layer of aerosol generating material 244. The support or substrate layer 242 may comprise card and the susceptor layer 243 may comprise a layer of aluminum foil 243. The other elements of the aerosol provision device 202 shown in FIG. 6 correspond to the elements shown and described above in relation to FIG. 1.

One or more ferritic elements (not shown) may be provided below the one or more inductor coils 224a. The one or more ferritic elements have been found to improve the frequency response of the one or more inductor coils 224a.

The one or more magnets 250 as shown in FIGS. 5 and 6 may, for example, comprise button shaped magnets. The one or more magnets 250 may have a diameter of e.g. 10 mm and a thickness of e.g. 1 mm. Other arrangements are contemplated wherein the one or more magnets 250 may have a diameter <5 mm, 5-6 mm, 6-7 mm, 7-8 mm, 8-9 mm, 9-10 mm, 10-11 mm, 11-12 mm, 12-13 mm, 13-14 mm, 14-15 mm and >15 mm. Arrangements are also contemplated wherein the one or more magnets 250 may have a thickness <0.5 mm, 0.5-0.6 mm, 0.6-0.7 mm, 0.7-0.8 mm, 0.8-0.9 mm, 0.9-1.0 mm, 1.0-1.1 mm, 1.1-1.2 mm, 1.2-1.3 mm, 1.3-1.4 mm, 1.4-1.5 mm and >1.5 mm.

More generally, embodiments are contemplated wherein one or more magnetic field shaping or magnetic flux concentrating elements (e.g. one or more magnets 250 or a ferritic material) are provided optionally above one or more induction coils 224a. The one or more magnetic field shaping or magnetic flux concentrating elements (e.g. one or more magnets 250) may have a round or button shape. Alternatively, the one or more magnetic field shaping or magnetic flux concentrating elements (e.g. one or more magnets 250) may have a triangular, rectangular, square, oval, polygonal, regular or irregular shape.

The one or more magnets 250 may be formed from neodymium iron boron (NdFeB), samarium cobalt (SmCo), alnico, ceramic or ferrite magnetic material.

The one or more magnets 250 function as a magnetic field shaping or magnetic flux concentrating element. Embodiments are contemplated wherein either a single magnetic field shaping element or magnetic flux concentrating element is provided or wherein multiple magnetic field shaping or magnetic flux concentrating elements are provided. The one or more magnetic field shaping or magnetic flux concentrating elements may, for example, comprise one or more permanent magnets 250. The one or more magnetic field shaping or magnetic flux concentrating elements 250 may be arranged to shape the magnetic field or concentrate magnetic flux generated by one or more magnetic field generators which may comprise one or more inductor coils 224a.

Other embodiments are contemplated wherein the one or more magnetic field shaping elements may comprise a ferritic material which may not be magnetic. The ferritic material may comprise a ceramic compound composed of iron oxide (Fe₂O₃) combined chemically with one or more additional metallic elements. For example, the ferritic material may comprise ferritic stainless steel (which may comprise ≥12% chromium).

The one or more magnets 250 (or the ferritic material) may be located at a position or distance 8.3 mm above or spaced from the inductor coil 224a. However, according to other arrangements the one or more magnets 250 (or the ferritic material) may be positioned at a distance <2 mm, 2-3 mm, 3-4 mm, 4-5 mm, 5-6 mm, 6-7 mm, 7-8 mm, 8-9 mm, 9-10 mm, 10-11 mm, 11-12 mm or >12 mm above or from the inductor coil 224a.

The one or more inductor coils 224a may be substantially planar. For example, the one or more inductor coils 224a may have a trapezoidal shape. However, other arrangements are contemplated wherein the one or more inductor coils 224a may have a different shape e.g. triangular, square, rectangular, pentagonal, hexagonal, circular, ellipsoidal or other shape.

The one or more magnetic field shaping or magnetic flux concentrating elements may comprise one or more permanent magnets 250, ferromagnets or ferrimagnets. The one or more magnetic field shaping or magnetic flux concentrating elements (e.g. one or more magnets 250) may be centered relative to the inductor coil 224a such that a central cylindrical axis of the one or more magnets 250 may be arranged so as to be coaxial with a longitudinal axis of the one or more inductor coils 224a. The inductor coil 224a may, for example, comprise a plurality of spiral or circular tracks which may be arranged about a longitudinal axis. According to other embodiments the one or more magnetic field shaping or magnetic flux concentrating elements may comprise a ferritic material such as ferritic stainless steel.

With reference to FIG. 5, the thermocouple 260 was positioned for testing and calibration purposes so as to contact the upper surface of the aluminum foil susceptor 243 at a point which lies on the axis defined by a central cylindrical axis of the one or more magnets 250 and a spiral or longitudinal axis of the inductor coil 224a. The thermocouple 260 was provided in order to enable physical measurements of the temperature of the susceptor 243 to be measured as the susceptor 243 was heated via the actuation of the induction coil 224a during a session of use.

The aerosol provision device 202 comprises a body portion and may include a removable mouthpiece. The one or more permanent magnets, ferromagnets or ferrimagnets 250 may be arranged to releasably secure the removable mouthpiece to the body portion of the aerosol provision device 202.

With reference to the various embodiments shown in FIG. 5 one or more permanent magnets 250 act as one or more magnetic field shaping element or magnetic flux concentrating elements. However, other embodiments are contemplated wherein one or more inductors, inductor elements, inductor coils, electromagnets or ferritic material may be provided in order to act as one or more magnetic field shaping element or magnetic flux concentrating elements.

As shown in FIG. 6, the aerosol provision device 202 may have a reception region 225 for receiving the aerosol generating article 204. The one or more magnetic field shaping or magnetic flux concentrating elements may be arranged on an opposite side of the reception region 225 to that of the inductor coil 224a. For example, the one or more magnetic field shaping or magnetic flux concentrating elements may be arranged in the lid portion of the aerosol provision device 202 whereas the one or more induction coil(s) 224a may be provided in the base portion of the aerosol provision device 202. The reception region 225 may be provided between the base portion and the lid portion of the aerosol provision device 202.

According to other embodiments the one or more magnetic field shaping or magnetic flux concentrating elements may be arranged in the base portion of the aerosol provision device 202 and the one or more induction coil(s) 224a may be provided in the lid portion of the aerosol provision device 202. The reception region 225 may be provided between the base portion and the lid portion of the aerosol provision device 202.

The one or more magnetic field shaping elements or magnetic flux concentrating elements may be arranged to shape or concentrate a time varying magnetic field generated by the one or more magnetic field generators or inductor coils 224a on to a target region of the aerosol generating article 204.

The aerosol generator or induction coil 224a may be arranged on a first side of the reception region 225 and the one or more magnetic field shaping or magnetic flux concentrating elements (e.g. one or more magnets 250) may be arranged on a second different side of the reception region 225. The reception region 225 may be intermediate one or more induction coils(s) 224a and one or more permanent magnets 250.

The aerosol provision device 202 may further comprise an aerosol chamber arranged to receive aerosol generated from the aerosol generating article 204. The aerosol chamber was removed from the aerosol provision device 202 shown in FIG. 5 for testing purposes.

The aerosol provision device 202 may further comprise a first device which is arranged to move, translate or rotate the aerosol generating article 204 relative to the aerosol generator or inductor coil 224a during a session of use. For example, the aerosol generating article 204 may be rotated or translated relative to the aerosol generator or inductor coil 224a. Reference is also made to the rotational drive mechanism as described above with reference to FIG. 2.

The aerosol provision device 202 may comprise a plurality of magnetic field generators i.e. the aerosol provision device 202 may comprise a plurality of inductor coils 224a. The plurality of magnetic field generators may be arranged to cause aerosol to be generated from different portions of an aerosol generating article 204 during a session of use. Accordingly, the aerosol provision device 202 may also comprise a plurality of aerosol chambers (not shown). At least some or each aerosol chamber may be arranged to receive aerosol generated from different portions of an aerosol generating article 204 during a session of use.

An aerosol generating system is disclosed which comprises the combination of an aerosol provision device 202 and an aerosol generating article 204. The aerosol generating article 204 may comprise aerosol generating material and a susceptor 243 e.g. aluminum foil. The aerosol generating article 204 may be arranged in the form of a planar aerosol generating article 204 i.e. having a width w, length l and depth d and wherein w>d and l>d. The susceptor 243 may comprise a metallic foil such as aluminum foil. According to other arrangements the susceptor 243 may comprise steel.

The aerosol provision device 202 may further comprise a controller or processor which is arranged to determine a calculated temperature (TCalc) of the susceptor 243 based upon determining the resonance frequency of a resonance circuit which includes the inductor coil 224a and the susceptor 243. It will be understood that there is a correlation between the determined resonance frequency of a resonance circuit which includes the inductor coil 224a and susceptor 243 and the corresponding temperature induced in the susceptor 243 arranged in close proximity to the inductor coil 224a. It will be understood that as the susceptor 243 is heated up via the actuation of the induction coil 224a during a session of use then the resistivity of the susceptor 243 will increase and hence the resonance frequency of the resonance circuit will reduce.

According to an arrangement the susceptor 243 may be heated by controlling a drive frequency f of a RLC resonance circuit. A controller may be provided which is arranged to determine the resonant frequency fᵣ of the RLC resonance circuit and then to provide an AC or RF voltage at the resonant frequency fᵣ in order to heat the susceptor 243.

The resonance circuit may comprise a resistor, a capacitor and an inductor connected in series. The resonance circuit can be considered as having a resistance R, an inductance L and a capacitance C. The inductance L of the circuit is provided by the inductor 224a arranged for inductive heating of the susceptor 243. The inductive heating of the susceptor 243 is via an alternating magnetic field generated by the inductor 224a which induces Joule heating and/or magnetic hysteresis losses in the susceptor 243. A portion of the inductance L of the circuit may be due to the magnetic permeability of the susceptor 243. The alternating magnetic field generated by the inductor 224a is generated by an alternating current flowing through the inductor 224a. The alternating current flowing through the inductor 224a is an alternating current flowing through the RLC resonance circuit. The inductor 224a may, for example, be in the form of a coiled wire, for example a copper coil. The inductor 224a may comprise, for example, a LITZ (RTM) wire, for example a wire comprising a number of individually insulated wires twisted together. LITZ (RTM) wires may be particularly useful when drive frequencies f in the MHz range are used, as this may reduce power loss due to the skin effect, as is known per se. At these relatively high frequencies, lower values of inductance are required. As another example, the inductor 224a may comprise a coiled track on a printed circuit board. Using a coiled track on a printed circuit board may be useful as it provides for a rigid and self-supporting track, with a cross section which obviates any requirement for LITZ (RTM) wire (which may be expensive), which can be mass produced with a high reproducibility for low cost.

The capacitance C of the circuit is provided by a capacitor. The capacitor may be, for example, a Class 1 ceramic capacitor, for example a COG capacitor. The capacitance C may also comprise the stray capacitance of the circuit. However, this is or can be made negligible compared with the capacitance C provided by the capacitor.

The resistance R of the circuit may be provided by a resistor, the resistance of the track or wire connecting the components of the resonance circuit, the resistance of the inductor 224a, and the resistance to current flowing in the resonance circuit provided by the susceptor 243 arranged for energy transfer with the inductor 224a. It will be appreciated that the circuit need not necessarily comprise a resistor, and that the resistance R in the circuit may be provided by the resistance of the connecting track or wire, the inductor 224a and the susceptor 243.

The circuit may be driven by a H-Bridge driver. A H-Bridge driver is a driving element for providing an alternating current in the resonance circuit. The H-Bridge driver may be connected to a DC voltage supply and to an electrical ground. The DC voltage supply may be, for example, from a battery. The H-Bridge may be an integrated circuit, or may comprise discrete switching components which may be solid-state or mechanical. The H-bridge driver may, for example, comprise a High-efficiency Bridge Rectifier. As is known per se, the H-Bridge driver may provide an alternating current in the circuit from a DC voltage supply by reversing (and then restoring) the voltage across the circuit via switching components. This may be useful as it allows the RLC resonance circuit to be powered by a DC battery, and allows the frequency of the alternating current to be controlled.

The H-Bridge driver may be connected to a controller. The controller may control the H-Bridge or components thereof to provide an alternating current I in the RLC resonance circuit at a given drive frequency f. For example, the drive frequency f may be in the MHz range, for example in the range 0.5 MHz to 4 MHz, for example in the range 2 MHz to 3 MHz. It will be appreciated that other frequencies f or frequency ranges may be used, for example depending on the particular resonance circuit (and/or components thereof), controller, susceptor 243, and/or driving element used. For example, it will be appreciated that the resonant frequency fᵣ of the RLC circuit is dependent on the inductance L and capacitance C of the circuit which in turn is dependent on the inductor 224a, capacitor and susceptor 243. The range of drive frequencies f may be around the resonant frequency fᵣ of the particular RLC circuit and/or the susceptor 243.

It will be appreciated that the resonance circuit and/or drive frequency or range of drive frequencies f used may be selected based on other factors for a given susceptor 243. For example, in order to improve the transfer of energy from the inductor 224a to the susceptor 243, it may be useful to ensure that the skin depth (i.e. the depth from the surface of the susceptor 243 within which the alternating magnetic field from the inductor 224a is absorbed) is less, for example a factor of two to three times less, than the thickness of the susceptor 243 material. The skin depth differs for different materials and construction of susceptors 243, and reduces with increasing drive frequency f. In some examples, therefore, it may be beneficial to use relatively high drive frequencies f. On the other hand, for example, in order to reduce the proportion of power supplied to the resonance circuit and/or driving element that is lost as heat within the electronics, it may be beneficial to use lower drive frequencies f. In some examples, a compromise between these factors may therefore be chosen as appropriate and/or desired.

The aerosol provision device 202 may comprise a sensor for detecting the inductive coupling between the induction coil 224a and the susceptor 243, and the controller or processor may input the detected inductive coupling into an algorithm in order to determine a corresponding calculated temperature (TCalc) of the susceptor 243.

It will be understood, therefore, that for testing and calibration purposes two different temperature measurements may be obtained namely: (i) a directly measured temperature (TC) of the susceptor 243 as directly measured by the thermocouple 260; and (ii) a calculated temperature (TCalc) as determined by measuring the resonance frequency of the RLC drive circuit and using a known correlation or calibration function between the measured resonance frequency and the calculated temperature of an associated susceptor 243.

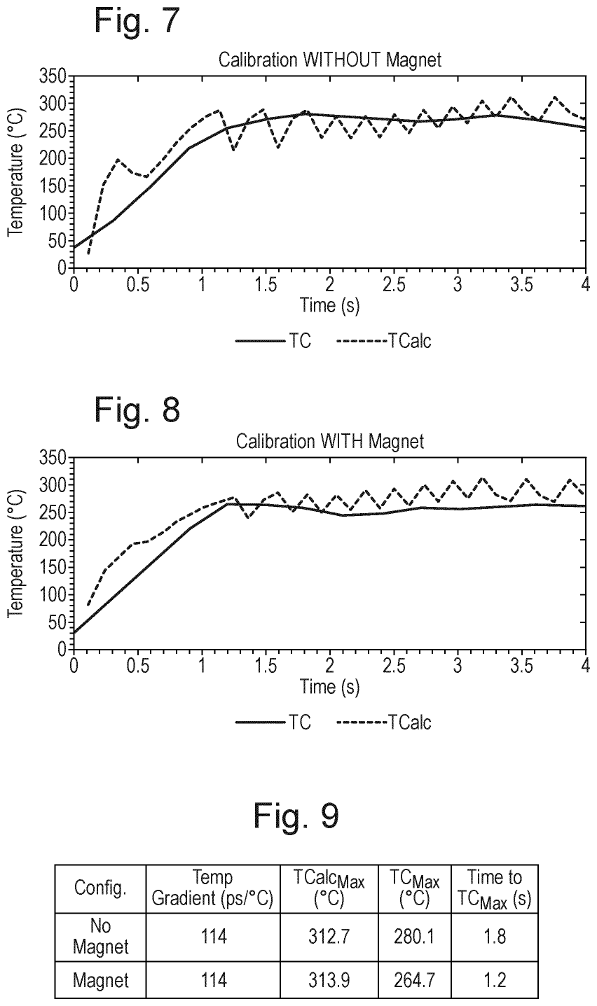

FIG. 7 shows how the thermocouple measured temperature (TC) and the inductive-coupling calculated temperature (TCalc) of the aluminum foil susceptor 243 were determined to increase during a calibration routine performed without a magnet 250 being present adjacent the inductor coil 224a i.e. in the absence of a magnetic field shaping or magnetic flux concentrating element. The calibration routine was performed over a time period of 4 s and a desired set point temperature of 275° C. was set for the susceptor 243 i.e. it was desired to heat the susceptor to a temperature of 275° C.

In this arrangement the inductor coil 224a was actuated with the intention of heating the susceptor 243 up to a temperature of 275° C. as quickly as possible and thereafter the controller was set to maintain the temperature of the susceptor 243 at a temperature of 275° C. The maximum temperature directly measured by the thermocouple (TC_{Max}) was determined to be 280.1° C. and this temperature was reached after a time of 1.8 s.

FIG. 8 shows how the thermocouple measured temperature (TC) and the inductive-coupling calculated temperature (TCalc) of the aluminum foil susceptor 243 were determined to increase during a calibration routine performed with a magnet 250 being present above the inductor coil 224a as shown in FIG. 6. The magnet 250 acted as a magnetic field shaping element or magnetic flux concentrating element.

The maximum temperature (TC_{Max}) directly measured by the thermocouple 260 was lower at 264.7° C. but significantly this temperature was reached after a shorter period of time namely 1.2 s. This is 0.6 s quicker than when no magnet 250 was present.

Accordingly, the magnet 250 which acted as a magnetic field shaping or magnetic flux concentrating element decreased the ramp up time to the desired set point temperature. It will be appreciated that this is particularly beneficial.

The difference between the maximum temperature 280.1° C. of the aluminum susceptor 243 as directly measured by the thermocouple 260 with the magnet 250 removed and with the magnet 250 present (i.e. 264.7° C.) both fall within ±5% of the desired set point temperature of 275° C. Furthermore, this was within the tolerance limit for the calibration protocol which was set at 10%.

The temperature gradient (ps/° C.), the maximum calculated temperature TCalc_{Max}, the maximum directly measured thermocouple temperature TC_{Max} and the time to reach the maximum thermocouple measured temperature TC_{Max} are summarised in a table as shown in FIG. 9 for the two different scenarios namely when no magnet 250 was present and when a magnet 250 was present.

The temperature gradient as stated in FIG. 9 is a measure of the change in resonant waveform time period per degree Celsius. According to various arrangements, the temperature of the susceptor 243 may be determined by measuring the damped resonant frequency of a series resistor-inductor-capacitor network. The capacitance will be fixed (PCB component), the resistance is partly due to the resistivity of the susceptor foil 243 and the inductance is mostly fixed by the inductor coil 224a. It will be understood that as the temperature of the susceptor 243 increases then the foil resistivity and the z-height will both increase and this will result in a reduction of the measured resonance frequency. The temperature gradient as stated in FIG. 9 is a measure of the change in resonant waveform time period per degree Celsius (where time period is 1/frequency). For example, if the resonance frequency at 100° C. is 2.1980 MHz then the time period=1/2.198 MHz=454.96 ns. If the resonance frequency at a temperature 1° C. higher i.e. 101° C. is 2.1975 MHz then the temperature gradient is 95 ps/° C. i.e. 1/(454.96 ns+95 ps)=2.1975 MHz. The time-period-versus-temperature or resonance frequency-versus-temperature response is non-linear and hence determining the calculated temperature by measuring the resonance frequency is most accurate at the two temperatures used for calibration which may be ambient (e.g. 22° C.) and a high temperature calibration point e.g. 275° C.

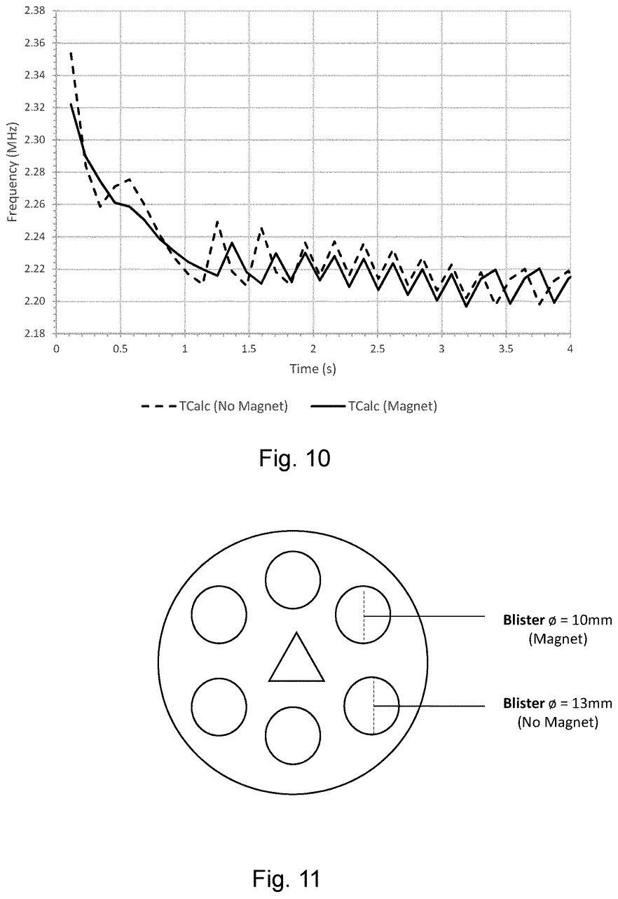

FIG. 10 shows how the measured resonance frequency of the resonance circuit including the inductor coil 224a for the above described arrangement both with and without the removable magnet 250 being present decreased during the course of a calibration routine. The calibration routine was run for a time period of 4 seconds and a desired set point temperature of 275° C. was set for the susceptor 243.

It can be seen from FIG. 10 that the presence of a magnetic retainer and mouthpiece magnet 250 appeared to have a negligible effect upon the calculated temperature TCalc of the susceptor 243 as determined by measuring the resonance frequency of the RLC drive circuit.

Accordingly, the presence of the magnet 250 does not impact upon the calibration process.

It will be understood that an aerosol provision device once manufactured needs to be individually tested and calibrated prior to being sold commercially to an end user.

Testing was performed using two different test aerosol generating articles. The first test aerosol generating article comprised a card substrate 242 with an aluminum foil layer 243 adhered thereto. The second test aerosol generating article comprised a card substrate 242 with an aluminum foil layer 243 adhered thereto and with aerosol generating material (i.e. gel) 244 provided upon the aluminum foil layer 243. The aluminum foil layer 243 of the first and second test aerosol generating articles 204 acted as a susceptor 243.

FIG. 11 shows an image of a first test aerosol generating article or consumable 204 showing resulting blister patterns which resulted due to operation of the aerosol provision device 202 both with and without the removable magnet 250 being present. In this particular test a single inductor coil 224a was utilized which had a circular profile.

The heat generated in the aluminum foil susceptor 243 by the inductor coil 224a having a circular profile can be seen to have caused corresponding circular blister patterns to appear on the surface of the test aerosol generating article 204. It will be understood that the test aerosol generating article 204 was rotated after each test and the six blister patterns which are apparent in FIG. 11 are the result of six separate tests both with and without the magnet 250 being present. When the magnet 250 was present the blister pattern had a diameter of approximately 10 mm. When the magnet 250 was absent the blister pattern had a larger diameter of approximately 13 mm. Accordingly, the susceptor foil surface blister is approximately 3 mm wider in diameter for the case when the magnet 250 is absent.

It is believed that the presence of the magnet 250 (or according to other embodiments a ferritic element) helps to localise the magnet field lines through the aerosol generating article 204 i.e. the magnet 250 concentrates the magnetic flux of the inductor coil 224a and hence the blister patterns observed in the test aerosol generating article 204 have a smaller diameter (10 mm) when a magnet 250 was positioned above the aerosol generating article 204. Accordingly, the magnet 250 acted as a magnetic field shaping element or magnetic flux concentrating element.

The presence of the magnet 250 has been found to result in a significant improvement (i.e. decrease) in the temperature ramp up time i.e. the time taken to reach a desired set point temperature from ambient which in the example shown in relation to FIG. 11 was a set point temperature of 300° C.

It will be appreciated that according to various embodiments an aerosol provision device 202 is provided having one or more magnetic field shaping elements (e.g. one or more magnets 250 or a ferritic material) which acts to shape, focus, concentrate or collimate a varying magnetic field generated by one or more inductor coils 224a. The effect of shaping, focusing, concentrating or collimating the varying magnetic field or the magnetic flux generated or emitted by the one or more inductor coils 224a reduces the time taken by the aerosol provision device 202 to reach a desired set point temperature.

Accordingly, a significant benefit of locating one or more magnets 250 (or ferritic material) in close proximity to the inductor coil 224a is that the aerosol provision device 202 has a reduced ramp up time. The ramp up time may be sufficiently short so that a user is now able to enjoy on-demand puffing. In particular, as shown in the table shown in FIG. 9 according to various arrangements a ramp time of e.g. 1.2 s may be achieved which is sufficiently short so as to permit a user to enjoy on-demand puffing. It will be understood that this is a significant development.

Further testing was performed with different types of vapor chambers. For example square, round and flat glass vapor chambers were tested both with and without the presence of one or more magnetic field shaping elements (or ferritic material) which were arranged to shape, focus, concentrate or collimate a varying magnetic field generated by the one or more magnetic field generators.

A first type (“Type 1”) of consumable was tested comprising a substantially circular aerosol generating article comprising a substrate having an aluminum foil layer but for testing purposes the substrate did not include aerosol generating material. The aerosol generating article was rotated relative to an inductive heating element. Eight samples were taken per aerosol generating article as the aerosol generating article was being rotated. A total of 10 aerosol generating articles were tested so that in total 80 data points were obtained.

A second type (“Type 2”) of consumable was tested comprising a substantially slim line aerosol generating article comprising a substrate having an aluminum foil layer but for testing purposes the substrate did not include aerosol generating material. The aerosol generating article was translated relative to an inductive heating element. The consumable comprised a single sided open consumable having five zones or discrete portions. Accordingly, five samples were taken per aerosol generating article as the aerosol generating article was being translated. A total of 16 aerosol generating articles were tested so that in total 80 data points were obtained.

The results of testing the two different types of consumable are detailed in the table below:

| | | Average | Average | Average | Average | Observed |
|---|---|---|---|---|---|---|
| | | min | max | median | delta | max delta |
| Consumable | | frequency | frequency | frequency | frequency | frequency |
| type | Vapor chamber | (kHz) | (kHz) | (kHz) | (kHz) | (kHz) |
| Type 1 | Square without magnet | 2140 | 2297 | 2252 | 157 | 228 |
| Type 1 | Square with magnet | 2197 | 2313 | 2263 | 117 | 149 |
| Type 1 | Round without magnet | 2171 | 2308 | 2271 | 137 | 218 |
| Type 1 | Round with magnet | 2182 | 2305 | 2271 | 123 | 197 |
| Type 1 | Flat glass with magnet | 2187 | 2310 | 2252 | 122 | 170 |
| Type 1 | Flat glass with magnet | 2207 | 2305 | 2255 | 98 | 152 |
| Type 2 | Square without magnet | 2249 | 2303 | 2294 | 54 | 259 |
| Type 2 | Square with magnet | 2284 | 2330 | 2321 | 46 | 134 |
| Type 2 | Round without magnet | 2272 | 2334 | 2324 | 62 | 411 |
| Type 2 | Round with magnet | 2286 | 2321 | 2306 | 35 | 100 |
| Type 2 | Flat glass without magnet | 2247 | 2309 | 2291 | 63 | 148 |
| Type 2 | Flat glass with magnet | 2259 | 2295 | 2279 | 37 | 84 |

From the various data points the average minimum frequency, average maximum frequency and average median frequency were determined. In addition, the average delta frequency delta and the observed maximum delta frequency were determined. As can be seen from the data presented in the table, as indicated by the values highlighted in bold and underlined, for both types of consumable and for all types of vapor chamber the average delta frequency and the observed maximum delta frequency were lower when the vapor chamber was provided with a magnet.

It will be understood that the larger values of the average delta frequency which were obtained with a vapor chamber without a magnet indicate that there is a greater variation in the determined resonance frequency. By contrast, when a vapor chamber was tested which included a magnet then the average delta frequency was higher.

It will be appreciated, therefore, that the presence of the magnet (or a ferritic element) results in a more consistent (less variation) in frequency response and allows the susceptor to get hotter more quickly. Overall, a reduced average delta frequency results in improved performance.

According to various embodiments the aerosol generating article may comprise a substantially circular or oval substrate having a first surface and a second surface. The substrate may, for example, comprise paper, card or aluminum foil. Other embodiments are contemplated wherein the substrate may comprise multiple layers arranged in a sandwich manner. For example, the substrate may comprise a paper or card substrate having a first aluminum foil layer arranged on a first surface and a second aluminum foil layer arranged on a second surface.

The aerosol generating article may comprise either an open or a closed type of consumable. For example, it will be understood that an open consumable is a type of consumable comprising aerosol generating article wherein the aerosol generating material is provided on one or more outer or outermost surfaces of the aerosol generating article. By contrast, it will be understood that a closed type of consumable comprises an aerosol generating article wherein aerosol generating material is not provided on an outer or an outermost surface of the consumable but rather is provided on one or more internal surfaces. For example, according to various embodiments a closed consumable may be provided wherein one or both outer or outermost surface(s) of the aerosol generating article comprise a gas impermeable layer such as a plastic or other material. For example, embodiments are contemplated wherein an aerosol generating article is provided comprising an innermost substrate having one or more layers of aerosol generating material provided on one or both sides of the substrate and wherein the aerosol generating article is encapsulated or otherwise housed within a housing which is made from a material which is gas impermeable. A closed type of consumable may comprise a housing having an air inlet and an aerosol outlet. The aerosol outlet may comprise a mouthpiece.

According to various embodiments the aerosol generating article may have a length (L), width (W) and thickness (T), wherein the length (L) of the aerosol generating article is greater than the width (W) and/or the thickness (T). The aerosol generating article may have a longitudinal axis and may have a first airflow input end and a second airflow output end. For example, the aerosol generating article may comprise a prism having a first end face and a second end face. The first end face may comprise a region wherein air enters the aerosol generating article in use and the second end face may comprise a region wherein aerosol generated within the aerosol generating article exits the aerosol generating article in use.

Embodiments are contemplated wherein the second end face further comprises a mouthpiece. For example, the aerosol generating article may comprise a distal end (via which air may be arranged to enter the aerosol generating article) and a proximal end (which may comprise a mouthpiece and wherein a user may draw aerosol generated within the aerosol generating article).

According to various embodiments aerosol generating material may be provided on either a first surface and/or a second surface of a substrate. For example, an aerosol generating article may be provided which is either single or double sided. A single sided aerosol generating article may be activated by a single array of heating elements. A double sided aerosol generating article may be activated by a double array of heating elements which in use are provided on both sides of the aerosol generating article.

Embodiments are contemplated wherein the aerosol generating article may be rotated and/or translated relative to one or more aerosol generators. The one or more aerosol generators may comprise, for example, a single aerosol generator or alternatively a plurality of aerosol generators may be arranged, for example, in an array. Embodiments are contemplated wherein aerosol generators may be provided in a n×m array, wherein n=2, 3, 4, 5, 6, 7, 8, 9, 10 or >10 and wherein m=2, 3, 4, 5, 6, 7, 8, 9, 10 or >10. For example, aerosol generators may be provided in a 2×2 array, a 2×3 array, a 2×4 array, a 2×5 array, a 2×6 array, a 2×7 array, a 2×8 array, a 2×9 array or a 2×10 array.

According to various embodiments the one or more aerosol generators may comprise one or more resistive heaters or resistive heating elements. According to other embodiments the one or more aerosol generators may comprise one or more inductive heaters or inductive heating elements. Embodiments are also contemplated wherein a plurality of resistive and inductive heating elements may be provided.

The aerosol generating article may be arranged to be rotated and/or translated relative to one or more aerosol generators so that the aerosol generating article is located adjacent the one or more aerosol generators and is heated from one side only. Alternatively, the aerosol generating article may be arranged to be rotated and/or translated relative to one or more aerosol generators so that the aerosol generating article is inserted between a first set of aerosol generators and a second set of aerosol generators. According to such an embodiment the aerosol generating article may be arranged to be heated either simultaneously or sequentially from two opposed sides.

Embodiments are also contemplated wherein the aerosol generating article may be prism shaped. For example, the aerosol generating article may comprise a triangular prism, a square shaped prism or a cylindrical prism. For example, the aerosol generating article may comprise a cylindrical aerosol generating article. The aerosol generating article may be rotated and/or translated relative to one or more aerosol generators. For example, the aerosol provision device may comprise a cavity into which a prismatic or cylindrical shaped aerosol generating article may be inserted. A matrix, strip or an array of aerosol generators may be provided at one or more locations around or along the cavity. The aerosol generating article may then be rotated and/or translated relative to the aerosol generators so that different portions of the aerosol generating article may be sequentially or progressively heated or otherwise accessed.

Embodiments are contemplated wherein an aerosol generating article may be translated relative to one of more aerosol generators. For example, the aerosol generating article may comprise a plurality of portions of aerosol generating material and the aerosol generating article may be translated in a longitudinal direction so that a plurality of separate portions of aerosol generating material may be activated or otherwise heated in series or sequentially.

Further embodiments are contemplated wherein the aerosol generating article may comprise a cylinder or more generally a prism. A plurality of aerosol generators may be arranged around or about the cylindrical or prismatic shaped aerosol generating article. It is contemplated that the aerosol generating article may be rotated within a static array of aerosol generators. Alternatively, the aerosol generating article may remain static and a plurality of aerosol generators may be rotated relative to the aerosol generating article. A yet further embodiment is contemplated wherein both the aerosol generating article and one or more aerosol generators are movable. For example, the aerosol generating article may be rotated and/or translated at a first speed v1 and one or more aerosol generators may be rotated and/or translated at a second speed v2. Embodiments are contemplated wherein in a mode of operation v1>v2. Embodiments are contemplated wherein in a mode of operation v1=v2. Embodiments are also contemplated wherein in a mode of operation v1<v2.

According to various embodiments the aerosol generating article may comprise a flat or planar consumable having a longitudinal axis. The aerosol generating article may be translated in a direction parallel to the longitudinal axis. Other embodiments are contemplated wherein the aerosol generating article comprises a cylindrical consumable having a longitudinal axis. The cylindrical consumable may be rotated about the longitudinal and/or may be translated in a direction parallel to the longitudinal axis. The aerosol generating article may be single side or double sided. A double sided consumable may be heated, in use, from both sides.

In order to address various issues and advance the art, this disclosure shows by way of illustration various embodiments. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. An aerosol provision device comprising:
an aerosol generator comprising one or more magnetic field generators; and
one or more magnetic field shaping elements arranged to shape, focus, concentrate or collimate a varying magnetic field generated by the one or more magnetic field generators.

2. An aerosol provision device as claimed in claim 1, wherein the aerosol generator comprises one or more inductors, inductor elements or inductor coils.

3. An aerosol provision device as claimed in claim 2, wherein the one or more inductors, inductor elements or inductor coils are substantially planar.

4. An aerosol provision device as claimed in claim 1, wherein the one or more magnetic field shaping elements comprise one or more permanent magnets, ferromagnets or ferrimagnets.

5. An aerosol provision device as claimed in claim 4, wherein the aerosol provision device further comprises a body portion and a removable mouthpiece, wherein the one or more permanent magnets, ferromagnets or ferrimagnets are arranged to releasably secure the mouthpiece to the body portion.

6. An aerosol provision device as claimed in claim 1, wherein the one or more magnetic field shaping elements comprise one or more inductors, inductor elements, inductor coils or electromagnets.

7. An aerosol provision device as claimed in claim 1, further comprising a reception region for receiving an aerosol generating article.

8. An aerosol provision device as claimed in claim 7, wherein the one or more magnetic field shaping elements are arranged to shape, focus, concentrate or collimate a varying magnetic field generated by the one or more magnetic field generators on to a target region of the aerosol generating article.

9. An aerosol provision device as claimed in claim 7, wherein the aerosol generator is arranged on a first side of the reception region and wherein the one or more magnetic field shaping elements are arranged on a second different side of the reception region.

10. An aerosol provision device as claimed in claim 9, further comprising one or more ferritic elements.

11. An aerosol provision device as claimed in claim 10, wherein the one or more ferritic elements comprise a ceramic compound composed of iron oxide (Fe₂O₃) combined chemically with one or more additional metallic elements.

12. An aerosol provision device as claimed in claim 10, wherein the one or more ferritic elements are arranged on the first side of the reception region.

13. An aerosol provision device as claimed in claim 12, wherein the one or more magnetic field generators have a first side and a second side, wherein the first side of the one or more magnetic field generators is arranged adjacent the one or more ferritic elements and wherein the second side of the one or more magnetic field generators is arranged adjacent the first side of the reception region.

14. An aerosol provision device as claimed in claim 7, further comprising an aerosol chamber arranged to receive aerosol generated from the aerosol generating article.

15. An aerosol provision device as claimed in claim 1, further comprising a first device arranged to move, translate or rotate an aerosol generating article relative to the aerosol generator during a session of use.

16. An aerosol provision device as claimed in claim 1, wherein the aerosol provision device comprises a plurality of magnetic field generators arranged to cause aerosol to be generated from different portions of an aerosol generating article during a session of use.

17. (canceled)

18. An aerosol provision device comprising:
an aerosol generator comprising one or more magnetic field generators; and
one or more magnetic flux concentrating elements arranged to concentrate magnetic flux generated by the one or more magnetic field generators.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. An aerosol generating system comprising:
an aerosol provision device as claimed in claim 1; and
an aerosol generating article comprising aerosol generating material and one or more susceptors.

36. (canceled)

37. (canceled)

38. (canceled)

39. (canceled)

40. (canceled)

41. (canceled)

42. (canceled)

43. An aerosol provision device comprising:
a reception region for receiving an aerosol generating article;
one or more aerosol generators comprising one or more magnetic field generators, wherein the one or more aerosol generators are arranged on a first side of the reception region; and
one or more magnetic field shaping elements arranged to shape, focus, concentrate or collimate a varying magnetic field generated by the one or more magnetic field generators, wherein the one or more magnetic field shaping elements are arranged on a second different side of the reception region.

44. (canceled)

45. (canceled)

46. (canceled)

47. (canceled)

48. (canceled)
